(19) United States
(12) Patent Application Publication
(10) Pub. No.: US 2011/0119297 A1
(43) Pub. Date: May 19, 2011

(54) SYSTEM AND METHOD FOR PROVIDING A PERSONAL CHARACTERISTIC-BASED CONTACT LIST

(76) Inventors: Robert Rango, Newport Coast, CA (US); Scott Pomerantz, Wyckoff, NJ (US); Nambirajan Seshadri, Irvine, CA (US)

(21) Appl. No.: 12/949,262

(22) Filed: Nov. 18, 2010

Related U.S. Application Data
(60) Provisional application No. 61/262,355, filed on Nov. 18, 2009.

(51) Int. Cl. G06F 17/30

(52) U.S. Cl. 707/769; 707/E17.014

(57) ABSTRACT

A system and method in a mobile computing device for utilizing personal characteristics (e.g., physical characteristics) of a person of interest to manage and/or recall information associated with such person. As non-limiting examples, a personal mobile computing device may be utilized to acquire image and/or voice information associated with a person of interest and utilize such acquired information to manage and/or recall information in a database (e.g., a contact list) associated with such person of interest.

### CROSS-REFERENCE TO RELATED APPLICATIONS/INCORPORATION BY REFERENCE

This patent application is related to and claims priority from provisional patent application Ser. No. 61/262,355 filed Nov. 18, 2009, and titled “SYSTEM AND METHOD FOR PROVIDING A PERSONAL CHARACTERISTIC-BASED CONTACT LIST,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

In a dynamic business and/or social environment, remembering and/or keeping track of acquaintances is typically difficult and often impossible.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method in a mobile computing device for utilizing personal characteristics (e.g., physical characteristics) of a person of interest to manage and/or recall information associated with such person.

These and other advantages, aspects and novel features of the present invention, as well as details of illustrative aspects thereof, will be more fully understood from the following description and drawings.

BRIEF DESCRIPTION OF SEVERAL VIEWS OF THE DRAWINGS

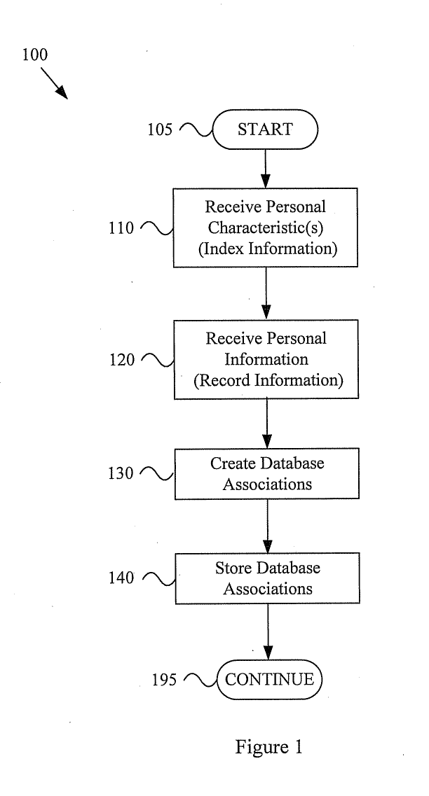

FIG. 1 is a flow diagram illustrating a non-limiting exemplary method for forming a personal information database, in accordance with various aspects of the present invention.

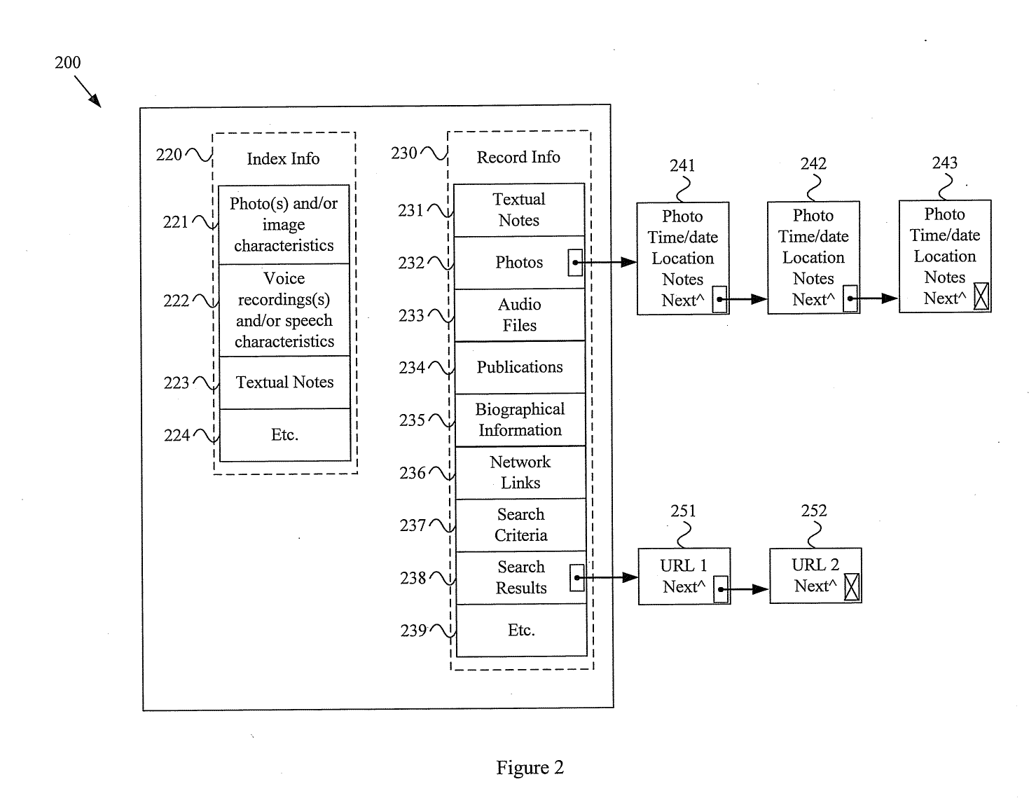

FIG. 2 is a diagram illustrating a non-limiting exemplary association between index information and record information, in accordance with various aspects of the present invention.

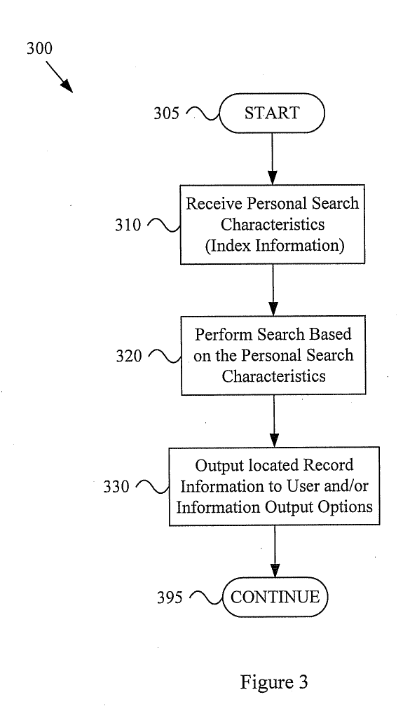

FIG. 3 is a flow diagram illustrating a non-limiting exemplary method for providing personal characteristic-based recall of personal information, in accordance with various aspects of the present invention.

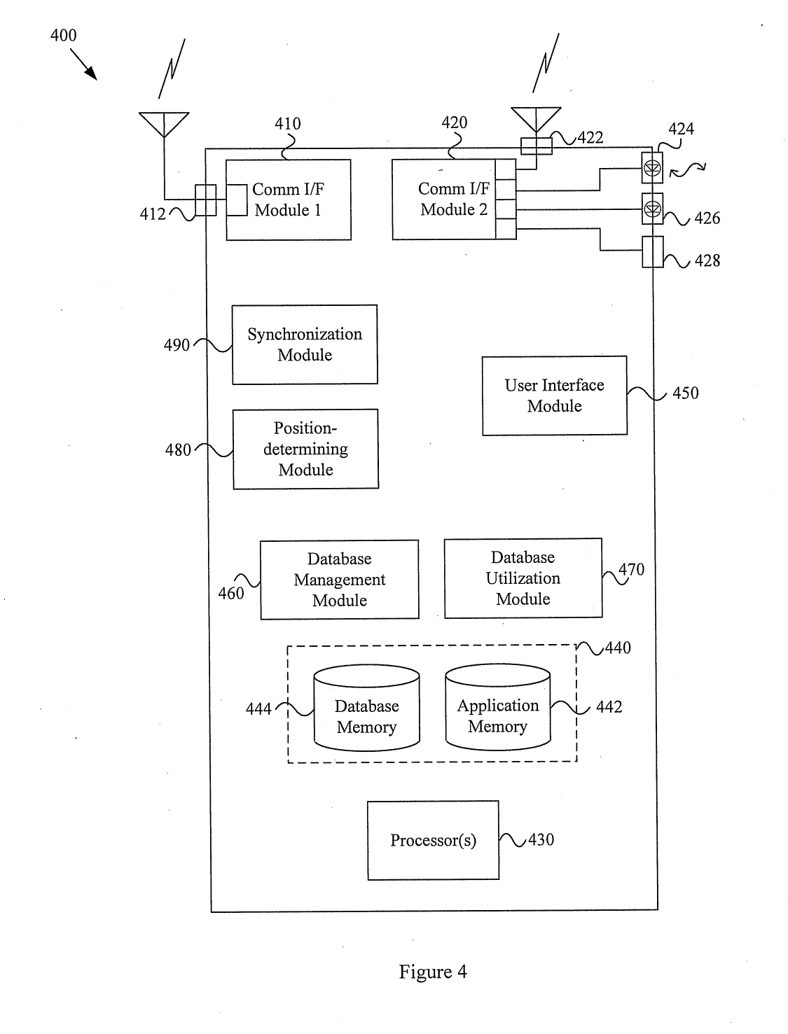

FIG. 4 is a block diagram illustrating a non-limiting exemplary portable computing device for providing personal characteristic-based recall of personal information, in accordance with various aspects of the present invention.

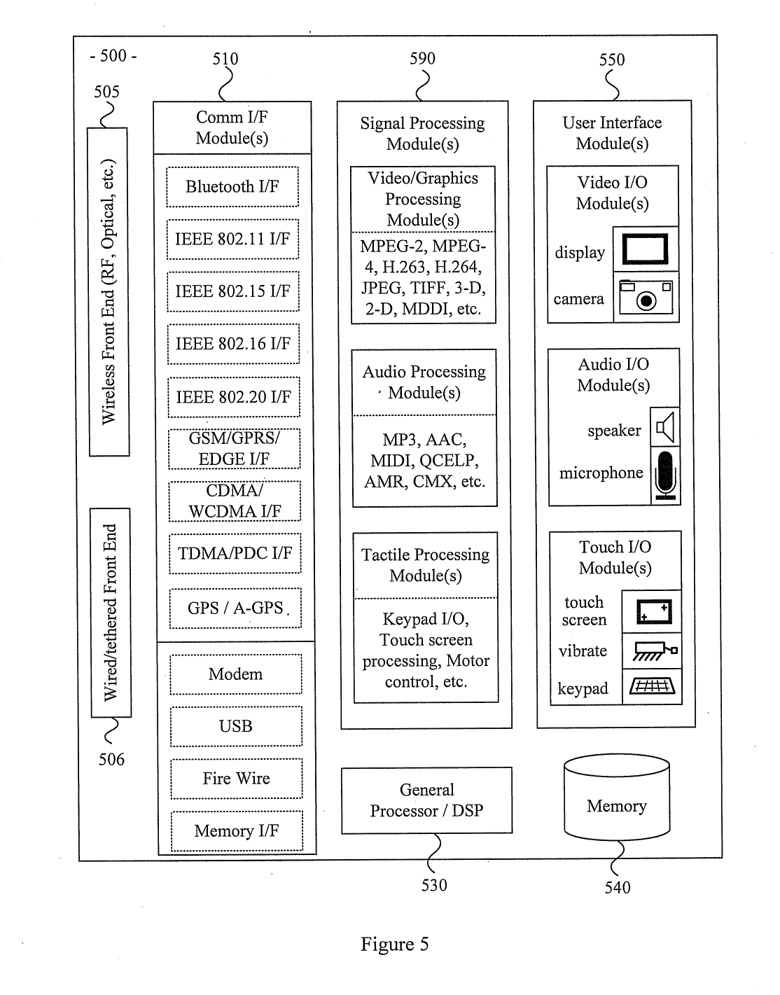

FIG. 5 is a block diagram illustrating a non-limiting exemplary portable computing device for providing personal characteristic-based recall of personal information, in accordance with various aspects of the present invention.

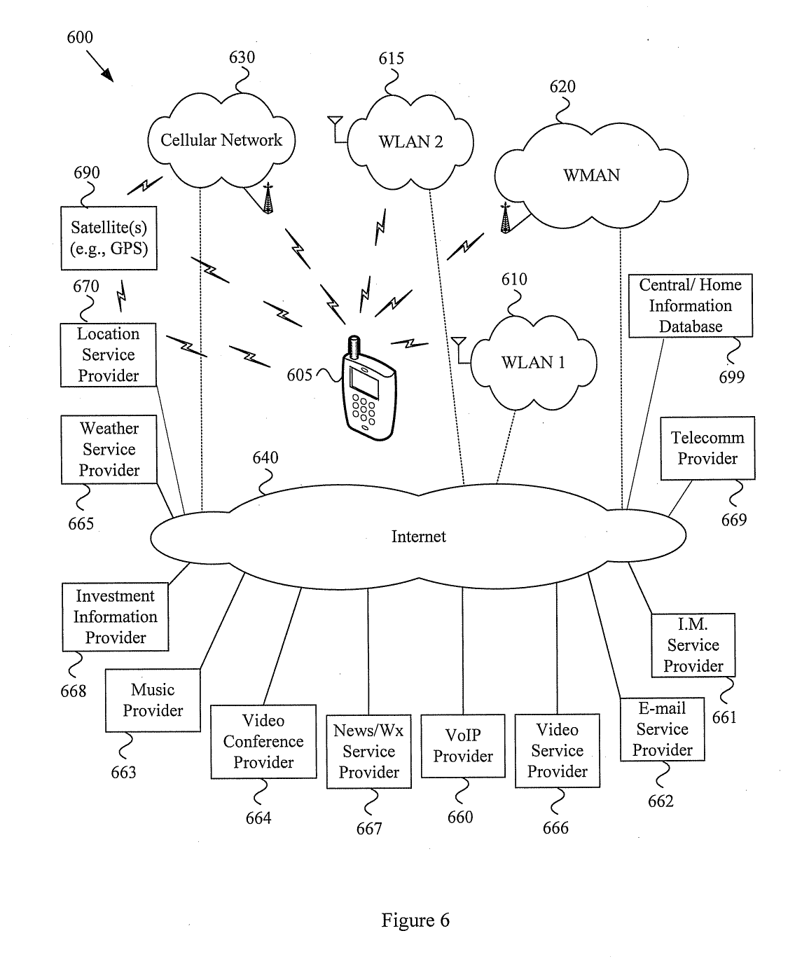

FIG. 6 is a diagram of a non-limiting exemplary system environment incorporating various aspects of the present invention.

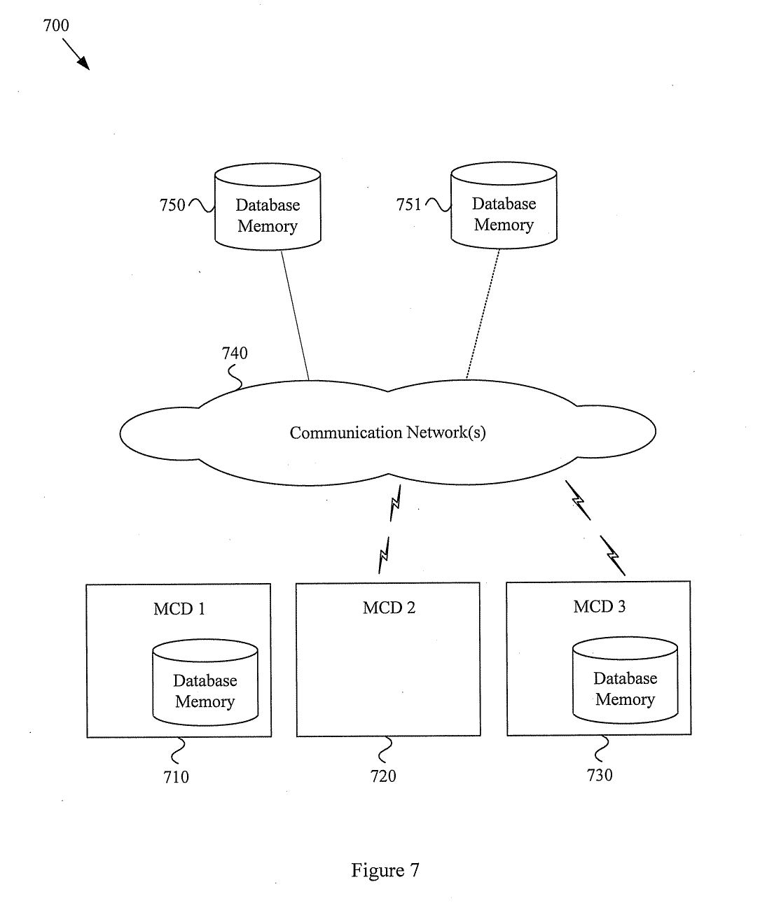

FIG. 7 is a diagram illustrating a non-limiting exemplary system comprising mobile computing devices, in accordance with various aspects of the present invention.

### DETAILED DESCRIPTION OF VARIOUS NON-LIMITING ASPECTS

The following discussion will refer to various communication modules, components or circuits. Such modules, components or circuits may generally comprise hardware, software or a combination thereof. Accordingly, the scope of various aspects of the present invention should not be limited by characteristics of particular hardware and/or software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by application-specific electrical circuitry (e.g., an application-specific integrated circuit (“ASIC”)).

The following discussion may also refer to communication networks (e.g., including access points, servers and/or databases) and various aspects thereof. For the following discussion, a communication network is generally the communication infrastructure through which a device with communication capability (e.g., a portable communication device) may communicate. For example and without limitation, a communication network may comprise a cellular communication network, a wireless metropolitan area network (WMAN), a wireless local area network (WLAN), a wireless personal area network (WPAN), etc. A particular communication network may, for example, generally have a corresponding communication protocol according to which a device may communicate with the communication network. Unless so claimed, the scope of various aspects of the present invention should not be limited by characteristics of a particular type of communication network.

Additionally, the following discussion will generally refer to a mobile computing device. Non-limiting examples of such a mobile computing device may include: a cellular telephone or any other mobile communication device (e.g., comprising a processor), a smart-phone, a personal digital assistant, a portable email device, a portable multimedia player, a personal positioning system, etc. A mobile computing device may, for example, correspond to any of a variety of personal (e.g., handheld) computing devices.

Various aspects of the present invention provide a system and/or method in a mobile computing device for utilizing personal characteristics (e.g., physical characteristics) of a person of interest to manage and/or recall information associated with such person. For example, a user of the mobile computing device (hereinafter succinctly referred to as “the user”) meets a person of interest, whether in a professional or social setting. Over time, the user's personal memory may fade and the identity of the person of interest (or other information related to the person of interest) may be lost. When the person of interest is re-encountered in the future, it would be beneficial for the user to be able to obtain information regarding the person of interest (overtly or in a covert manner) to avoid the effort (and perhaps the embarrassment) of re-obtaining such information. Such an opportunity may manifest itself in a real-time setting (e.g., with a “vaguely familiar” person presenting himself) or in a non-real-time setting (e.g., someone leaving a voice message with no source-identifying information; the desire to recall a name of someone with whom a photograph was taken; or any desire to later-determine the identity of a person, the immediate determination of which is not time-critical).

Mobile computing devices, in particular those with on-board information processing and/or communication capability, may be utilized to assist a user thereof in such situations. For example, a mobile computing device may provide the user with the capability to electronically obtain, manage and/or utilize personal indexing information (e.g., information about a person of interest that may be later utilized to look-up or otherwise recall other information about such person of interest). Also for example, the mobile computing device may provide the user with the capability to obtain, manage and/or utilize personal record information (e.g., information about a person of interest that may be stored for later recall).

In general, personal characteristics of a person of interest may be coupled to a contact list or to a personal database. For example, such characteristics may be linked to a stand-alone contact list (e.g., independent of other applications) or a contact list that is associated with another application (e.g., an email application or other application with a native contact list). Also for example, such characteristics may be linked to any of a variety of database types (e.g., private or shared, local or external, networked and/or centralized, etc.).

The personal characteristics may comprise any of a variety of characteristics that may be associated with a person. For example and without limitation, the personal characteristics may comprise physical characteristics (e.g., captured image, captured voice, height, weight, complexion, eye and hair color, retina characteristics, fingerprint characteristics, biometrics, DNA, accent, ethnicity, etc.). The personal characteristics may also comprise non-physical characteristics (e.g., personality traits, habits or preferences [e.g., favorite drink, type of car, smoker/non-smoker, shoe style, type A/B/C personality, favorite sports teams, exercise habits, establishments frequented, etc.], emotional characteristics, mannerisms, associations [e.g., friends and associates, family, company, academic institution, standards body, club, professional organization, state, nation, etc.], etc.).

In general, such personal characteristics may be utilized to index (or search) a contact list or other database to manage or retrieve personal record information (e.g., information about a person of interest that may be stored for later recall). For the following discussion, information of personal characteristics that may be utilized to index (or search) a contact list or other database will generally be referred to as “index information” or “personal index information”.

A database (e.g., a contact list, other personal database, shared database, networked database, etc.) may be populated with information about a person of interest that a user desires to be retrieved later. Such information may, for example and without limitation, comprise any or all of the personal characteristics discussed above. Such information may, for example, comprise any or all of: name information, contact information, title, company, age, academic credentials, technical expertise, publications, contact information, personal information, etc. For the following discussion, personal information associated with a person of interest that is stored and retrieved utilizing the index information will generally be referred to as “record information” or “personal record information”.

The database may comprise any of a variety of characteristics. For example, a database (e.g., a contact list) may be a local database (e.g., local to a mobile computing device), or a remote database (e.g., a database that a mobile computing device with communication capability may access). For example, the database may be physically located in any one or more of a variety of locations (e.g., internal to the mobile computing device, external to the mobile computing device, in a personal computer with which the mobile computing device is generally synchronized, an enterprise database, a central database [e.g., associated with a particular group or other private database, publicly accessible database, etc.], an institutional database, etc. The database may also, for example, include a plurality of databases that might or might not be geographically collocated.

The database additionally, for example, may exist exclusively for a single user or may, for example, be a database that is shared between many users (e.g., a corporate database, an institutional database, a business database, enterprise database, a school database, a database provided by an Internet company, etc.). The database may also, for example, reside on a user's personal desktop computer with which a mobile computing device synchronizes.

The database may include one or more levels of index information that may be used to access the desired record information. For example, a search may include searching based on one type or multiple types of personal characteristics. Thus, a plurality of different types of index information may be associated with record information for a person of interest. As a non-limiting example, one or more images may be associated with a particular personal record, along with one or more voice imprints, a company name, a geographical location, etc.

Similarly, the database may include one or more levels of record information that may, for example, be stored, searched for, and recalled. For example, a first level might include basic information and/or a list of categories for a second level of record information (e.g., “photos”, “contact information”, “publications”, “academic credentials”, “search engine hits”, etc.), from which a user may select the desired record information to be output to the user.

The database may include file information and/or links to file information (e.g., local memory file locations, networked file locations, URL addresses, etc.). Such file information may, for example, include text files (e.g., textual notes, resumes, biographies, articles, etc.). Also for example, such file information may comprise Video/Image files (e.g., video and/or image files of or related to a person of interest). Additionally for example, such file information may comprise audio files (e.g., audio notes, lectures, voice recordings, music, etc.) or any of a variety of other media files that might be associated with a person of interest.

The database may further, for example, comprise position/location information. For example, such location information might indicate where a particular person of interest has been encountered in the past. Such location information may, for example, comprise: GPS information, any of a variety of types of geographical coordinate information, venue information, conference/convention information, commercial establishment information, city information, etc. Also for example, the database may comprise search terms and/or addresses of search engines or search locations related to retrieving information regarding a person of interest. Such information may, for example, be utilized to initiate a search for recent information regarding a person of interest.

Later, when the stored personal information is desired, a user of the mobile computing device may utilize received, obtained or captured index information to index (or search) for record information associated with a person of interest. Such searching or information acquisition may be performed in real-time, non-real-time and/or a combination thereof.

Various aspects of the present invention will now be exemplified in a non-limiting manner by a set of figures and discussion thereof. It should be noted that the following figures and associated discussion are merely exemplary and should by no means limit the scope of various aspects of the present invention unless explicitly claimed.

Turning first to FIG. 1, such figure is a flow diagram illustrating a method 100 for forming a personal information database, in accordance with various aspects of the present invention. The exemplary method 100 may, for example and without limitation, be implemented by a mobile computing device (e.g., one or more modules thereof), either autonomously or in conjunction with other systems (e.g., external databases, information providing services, communication networks, external information capturing devices, etc.).

The exemplary method 100 may begin executing at step 105. The exemplary method 100 may begin executing in response to any of a variety of triggering events or conditions, non-limiting examples will now be presented. For example, the exemplary method 100 may begin executing in response to explicit user initiation (e.g., by a user explicitly executing an application or by a user explicitly directing an already-executing application to begin the process). Also for example, the exemplary method 100 may begin executing automatically (e.g., without direct user interaction) in response to personal index information and/or personal record information being received and/or acquired). Additionally for example, the exemplary method 100 may begin executing automatically when a user enters a particular venue or geographical region (e.g., based on detected position).

The exemplary method 100 may, at step 110, comprise receiving (or obtaining or acquiring) index information associated with a person of interest. Many non-limiting examples of such index information were presented previously. Such index information may, for example, comprise information of personal characteristics associated with a person of interest. As discussed above, such personal characteristics may, for example, comprise physical characteristics and/or non-physical characteristics.

Step 110 may comprise receiving (or obtaining or acquiring) index information in any of a variety of manners, non-limiting examples of which will now be presented. For example, step 110 may comprise receiving (or obtaining or acquiring) image information (still or moving) associated with a person of interest. For example, a user may capture an image of the person of interest with a camera (e.g., a digital camera). Such camera may, for example, be on-board the mobile computing device or may be separate from the mobile computing device but communicatively couple-able thereto. Also for example, such image index information may be obtained through a communication network (e.g., downloaded from a company website, downloaded from an Internet website, received attached to an email, etc.), captured from a multimedia computer file, copied from a conference proceedings document, captured from a news article, scanned from an article, captured from a moving picture file, etc.).

In another example, step 110 may comprise receiving (or obtaining or acquiring) voice information (or other audio) associated with a person of interest. For example, a user may record the voice of the person of interest with an audio recorder (e.g., a digital audio recorder). Such audio recorder may, for example, be on-board the mobile computing device or may be separate from the mobile computing device but communicatively couple-able thereto. Also for example, such voice index information may be obtained through a communication network (e.g., downloaded from a company website, downloaded from an Internet website, received attached to an email, etc.), captured from a multimedia computer file, excised or sampled from an audio lecture or other presentation, captured from a voice message, captured from an audio news article, etc.).

In still another example, step 110 may comprise receiving (or obtaining or acquiring) textual information describing characteristics of a person of interest. For example, a user of a mobile computing device may textually enter characteristics of a person of interest (e.g., physical and/or non-physical characteristics). For example, a user may utilize a keypad of (e.g., native or coupled to) a mobile computing device to enter information, such as, height, weight, complexion, ethnicity, accent or other speech characteristics, attire, affiliations, company, memberships, publications, encounter information (e.g., times, places, dates), etc.).

Note that initial index information (e.g., received concurrently or soon following a first encounter with a person of interest) may be supplemented and/or removed at any time after the initial receipt and/or entry of such information. For example, step 110 may be initiated to add or remove image, audio and/or textual index information associated with a particular person of interest. In such a manner, index information may be updated to maintain accuracy over time, index information may be replaced with higher quality (e.g., higher resolution image or lower noise audio) information over time, and index information may be accumulated (e.g., including multiple images and/or multiple audio recordings associated with a person of interest).

Step 110 may also comprise processing obtained personal characteristic information to place such information in a convenient form for indexing. For example, step 110 may comprise processing personal characteristic information (e.g., video, still image and/or audio information) to identify particular important and/or distinguishing characteristics thereof. As a non-limiting example, step 110 may comprise performing spectral analysis to identify particular speech characteristics associated with a person of interest or performing temporal signal analysis to identify particular temporal patterns of such speech. As another example, step 110 may comprise performing image analysis to identify particular facial characteristics associated with a person of interest (e.g., eye color and/or location, retinal characteristics, facial feature dimensions and/or locations, hair color and/or hairline location, complexion/color, height, face shape, existence of facial hair, etc.). Index information processed in such a manner may, for example, enhance the accuracy and/or real-time speed of processing. For example, personal index information acquired in real-time may be expeditiously analyzed for particular previously-identified distinguishing characteristics.

In general, step 110 may comprise receiving (or obtaining or acquiring) index information associated with a person of interest (e.g., a person of interest for whom it is desired to store personal record information). Accordingly, the scope of various aspects of the present invention should not be limited by characteristics of any particular manner of such receiving (or obtaining or acquiring) unless explicitly claimed.

The method 100 may, at step 120, comprise receiving (or obtaining or acquiring) personal record information associated with (or to be associated with) a person of interest. Many non-limiting examples of such record information were presented previously. Such record information may, for example, comprise information associated with a person of interest. As discussed above, such information may comprise any of a variety of different types of information (e.g., physical and/or non-physical characteristic information, association information, etc.).

Step 120 may comprise receiving (or obtaining or acquiring) such personal record information in any of a variety of manners, non-limiting examples of which will now be presented.

For example, step 120 may comprise receiving (or obtaining or acquiring) textual information to be associated with a person of interest. For example, a user of a mobile computing device may textually enter notes associated with a person of interest (e.g., physical and/or non-physical characteristics). For example, a user may utilize a keypad (e.g., a keypad of [e.g., native or coupled to] the mobile computing device) to enter such textual information.

Such textual information may, for example, comprise any or all of the characteristics discussed previously with regard to index and/or record information. For example and without limitation, such textual information may comprise textual information describing contact information (e.g., telephone number, email address, mail address, web addresses, etc.), biographical information, resume information, articles written, contributions made, languages spoken, committees served, organizations associated with, academic credentials and/or affiliations, memberships, encounter information (e.g., times, places, dates, etc.), habits, personal preferences, company(s) representing, and many other types of information that a user may be interested in recalling at a later date.

Also for example, step 120 may comprise receiving (or obtaining or acquiring) image information (still or moving) to be associated with a person of interest. Such image information may, for example, comprise any or all of the characteristics discussed previously with regard to image index and/or record information. For example, a user may capture an image of the person of interest with a camera (e.g., a digital camera) or video recorder or may capture an image of any other person of object to be associated with the person of interest. Such camera or video recorder may, for example, be on-board the mobile computing device or may be separate from the mobile computing device but communicatively couple-able thereto. Also for example, such image record information may be obtained through a communication network (e.g., downloaded from a company website, downloaded from an Internet website, downloaded from a file-sharing website, received attached to an email, etc.), captured from a multimedia computer file, copied from a conference proceedings document, captured from a news article, scanned from an article, captured from a moving picture file, etc.).

Further for example, step 120 may comprise receiving (or obtaining or acquiring) audio (e.g., speech) information to be associated with a person of interest. Such audio information may, for example, comprise any or all of the characteristics discussed previously with regard to audio index and/or record information. For example, a user may record the voice of the person of interest with an audio recorder (e.g., a digital audio recorder) or any other audio to be associated with the person of interest. Such audio recorder may, for example, be on-board the mobile computing device or may be separate from the mobile computing device but communicatively couple-able thereto. Also for example, such audio information may be obtained through a communication network (e.g., downloaded from a company website, downloaded from an Internet website, downloaded from a file-sharing website, received attached to an email, etc.), captured from a multimedia computer file, excised or sampled from an audio lecture, music or other presentation, captured from a voice message, captured from an audio news article, etc.). Further for example, such audio record information may comprise voice notes provided by a user regarding the person of interest.

Still further for example, step 120 may comprise receiving (or obtaining or acquiring) personal record information comprising link (or address) information (e.g., network address information, URL information, local file address information, etc.). Such link information may, for example, indicate where desired information associated with a person of interest may be found or where a search engine may look for the most recent information associated with the person of interest.

Yet further for example, step 120 may comprise receiving (or obtaining or acquiring) search term information. For example, a user may input terms that may be utilized by a search engine (either automatically [i.e., independent of user interaction] or under user direction) to search for information regarding a person of interest. Similarly, step 120 may comprise receiving (or obtaining or acquiring) personal record information by performing a search for such information (e.g., utilizing a set of predefined network addresses and/or search terms). Such searching may, for example, be performed in real-time (e.g., as such information is needed) or may also be performed before a real-time need for such information materializes. Such pre-searching (e.g., periodically updating, location-triggered updating, date-triggered updating, etc.) may be performed off-line to reduce real-time processing and/or communication demands.

As mentioned above, information may be automatically updated (i.e., independent of user interaction) or updated on command in either of steps 110 and 120. For example, such updating may comprise: periodic updating, updating in anticipation of an imminent encounter with particular people (e.g., at an annual conference, at a reunion, at a particular site, in a particular city, during a particular time window, etc.).

In general, step 120 may comprise receiving (or obtaining or acquiring) record information associated with (or to be associated with) a person of interest (e.g., a person of interest for whom it is desired to store personal record information). Accordingly, the scope of various aspects of the present invention should not be limited by characteristics of any particular manner of such receiving (or obtaining or acquiring) unless explicitly claimed.

The exemplary method 100 may, at step 130, comprise creating database (e.g., contact list) associations between the personal index information (e.g., as received at step 110) and the personal record information (e.g., as received at step 120). Step 130 may, for example, comprise linking one or more types of personal index information to one or more types of personal record information. Step 130 may comprise implementing such associations in any of a variety of manners, non-limiting examples of which will now be presented.

As a non-limiting example, the index and record information may be utilized to populate a data structure (e.g., in a database) that is designed for such associating. A non-limiting example of such a data structure is shown at FIG. 2.

Turning now to FIG. 2, such figure is a diagram illustrating a non-limiting exemplary association 200 between index information and record information, in accordance with various aspects of the present invention. Such association 200 is illustrated as a block diagram of an exemplary data structure. The data structure may, for example, comprise a multi-dimensional data structure. Such data structure may comprise, for example, a first array 220 comprising personal index information, many examples of which were presented previously. Note that each type of index information may comprise a plurality of instances of such type of information (e.g., in another dimension to the first array 220, in a linked list, etc.).

The first array 220 may, for example, comprise various types of index information. By way of non-limiting example, the first array 220 is shown comprising image (or photographic) information 221, voice recording information 222, textual information 223 and may include any of a variety of other types of index information 224, as discussed previously.

The data structure may also, for example, comprise a second array 230 comprising personal record information, many examples of which were presented previously. The second array 230 may, for example, comprise various types of personal record information. By way of non-limiting example, the second array 230 is shown comprising textual note information 231, image (or photographic) information 232, audio information 233, publication information 234, biographical information 235, network link (or address) information 236, search criteria information 237, search result information 238, and may include any of a variety of other types of record information 239, as discussed previously.

Note that each type of record information may comprise a plurality of instances of such type of information (e.g., in another dimension to the second array 230, in a linked list, etc.). As an example of such added dimension, image information 232 of the second array 230 is organized in a linked list of records (241, 242 and 243), each of which comprises image (or photo) information, time/date information, location information, and textual note information. As another example of such added dimension, search result information 238 of the second array 230 is organized in a link list of records (251 and 252), each of which comprises URL information indicating the location of various search results associated with the person of interest.

Though the example shown in FIG. 2 shows clear separation between index information and record information, such clear separation is not necessary. For example, an image file may be utilized both as index information and as record information. For example, a digital photograph may be utilized as index information associated with database searching for a particular person of interest, but may also be produced in response to a database search for the particular person of interest.

Referring back to FIG. 1, at step 140, database (e.g., contact list) information may be stored in a database. For example, step 140 may comprise storing index information (e.g., as received at step 110), record information (e.g., as received at step 120) and information associating such index information and record information (e.g., as developed at step 130) in a database (e.g., a contact list).

As explained previously, such database may comprise any of a variety of characteristics. For example, in a first scenario where the database resides entirely in the mobile computing device, step 140 may comprise storing all of the database information locally. Also for example, in a second scenario where the database resides in one or more databases external to the mobile computing device, step 140 may comprise communicating with such database(s) through a communication network (e.g., a wireless communication network, a wired communication network and/or a combination thereof) to store such information. Additionally for example, in a third scenario where the database is distributed between a local database of the mobile computing device and one or more databases external to the mobile computing device, step 140 may comprise performing a combination of local database storage and storage of the information in one or more remote databases via one or more communication networks.

The exemplary method 100 may, at step 195, comprise performing continued processing. For example, such continued processing may comprise looping execution flow back up to a previous step. Also for example, such continued processing may comprise waiting for a next trigger, in response to which execution flow will return to a previous step.

As mentioned previously, various aspects of the present invention may comprise various information (e.g., personal record information) being automatically updated. In such a scenario, step 195 may comprise periodically updating personal record information stored in the database. For example, in a first example, step 195 may comprise performing a regular periodic update of stored personal record information (e.g., based on stored URL, search engine and/or search term information). Also for example, in a second example, step 195 may comprise updating stored personal record information in response to a user command to perform such updating.

Various aspects of the exemplary method 100 may comprise interfacing with a user (e.g., a user of the mobile computing device). For example, various aspects of the exemplary method 100 may comprise interfacing with a user to manage various aspects of database formation and/or management. Non-limiting examples of such user interaction will now be provided.

A user may initiate an application performing the exemplary method 100, or a portion thereof, through a user interface of a mobile computing device. For example, a user may perform such initiation via pushbutton, keypad, touch screen, voice command, receiving/obtaining/acquiring information eligible for index and/or record information, etc. For example, the user may utilize the user interface of the mobile computing device to indicate a desire to add a new entry to the database, edit or otherwise maintain the database, add new information to the database, search the database, etc.

Additionally, for example, the user interface of the mobile computing device may provide the mechanisms by which a user may enter and/or edit index and/or record information. For example, the user interface may provide any of a variety of interfaces with which a user may capture index and/or record information (e.g., a camera, video recorder, audio recorder, keypad, search engine, touch screen, etc.). Also for example, the user interface may provide a database management interface (e.g., a file management interface) to add, delete and/or modify database information (e.g., data files) associated with an index and/or record. Such user interface may also, for example, provide convenient interface features whereby a user may conveniently analyze the contents of a particular index/record combination (e.g., review all indices associated with one or more particular records and/or review all record information associated with one or more indices).

As mentioned previously, various aspects of the present invention (e.g., the functionality discussed previously with regard to FIGS. 1-2) may be implemented in any of a variety of manners. For example, the discussion below will provide various non-limiting examples of device and/or system architectures. For example, the exemplary method steps discussed above may be performed by dedicated hardware and/or by a processor executing software/firmware instructions. Although the previous functionality was presented from the perspective of the mobile computing device, it should be realized that any or all of the various functionality may be implemented by various devices in conjunction with the mobile computing device and/or by various devices instead of the mobile computing device. Accordingly, the scope of various aspects of the present invention should not be limited by characteristics of a particular actor, unless explicitly claimed.

The previous discussion of FIGS. 1-2 primarily addressed database (e.g., contact list) formation and/or maintenance, though other topics were addressed as well. The following discussion of FIG. 3 will primarily focus on utilization of such database by a user (e.g., a user of a mobile computing device), though other topics will be addressed as well.

FIG. 3 is a flow diagram illustrating a non-limiting exemplary method 300 for providing personal characteristic-based recall of personal information, in accordance with various aspects of the present invention. The exemplary method 300 may share any or all aspects with the exemplary method 100 and database association 200 illustrated in FIGS. 1-2 and discussed previously.

The exemplary method 300 may begin executing at step 305. The exemplary method 100 may begin executing in response to any of a variety of triggering events or conditions, non-limiting examples of which will now be presented. For example, the exemplary method 300 may begin executing in response to explicit user initiation (e.g., by a user explicitly executing an application or by a user explicitly directing an already-executing application to begin the process). Also for example, the exemplary method 300 may begin executing automatically (e.g., without direct user interaction) in response to personal index information being received and/or acquired).

The exemplary method 300 may, at step 310, comprise receiving (or obtaining or acquiring) index information associated with a person of interest. Many non-limiting examples of such index information were presented previously. Such index information may, for example, comprise information of personal characteristics associated with a person of interest. As discussed above, such personal characteristics may, for example, comprise physical characteristics and/or non-physical characteristics associated with the person of interest. Step 310 may, for example, share any or all characteristics with step 110 of the exemplary method 100 illustrated in FIG. 1 and discussed previously.

For example, step 310 may comprise receiving (or obtaining or acquiring) index information in any of a variety of manners, non-limiting examples of which will now be presented. For example, step 310 may comprise receiving (or obtaining or acquiring) image information (still or moving) associated with a person of interest. For example, as discussed previously, a user may capture an image of the person of interest with a camera (e.g., a digital camera). Such image capture may, for example, be performed overtly or covertly. Such camera may, for example, be on-board the mobile computing device or may be separate from the mobile computing device but communicatively couple-able thereto. Also for example, such image index information may be obtained in any of a variety of alternative manners, many of which were discussed previously.

In another example, step 310 may comprise receiving (or obtaining or acquiring) voice information (or other audio) associated with a person of interest. For example, a user may record the voice of the person of interest with an audio recorder (e.g., a digital audio recorder). Such audio capture may, for example, be performed overtly or covertly. Such audio recorder may, for example, be on-board the mobile computing device or may be separate from the mobile computing device but communicatively couple-able thereto. Also for example, such voice index information may be obtained in any of a variety of alternative manners, many of which were discussed previously.

In still another example, step 310 may comprise receiving (or obtaining or acquiring) textual information describing characteristics of a person of interest. For example, a user of a mobile computing device may textually enter characteristics of a person of interest (e.g., physical and/or non-physical characteristics). For example, a user may utilize a keypad of (e.g., native or external to) a mobile computing device to enter information, many examples of which were presented previously.

Note that initial index information (e.g., received concurrently with or soon following a first encounter with a person of interest) may be supplemented, amended and/or removed at any time after the initial receipt and/or entry of such information. For example, step 310 may be initiated to add, amend or remove image, audio and/or textual index information associated with a particular person of interest. In such a manner, index information may be replaced with higher-quality index information. Also, in such a manner, index information may be aggregated (e.g., multiple instances of the same type of index information and/or instances of different types of index information) for a more reliable database search.

As with step 110 discussed previously, step 310 may also comprise processing obtained personal characteristic information to place such information in a convenient form for indexing. For example, step 310 may comprise processing personal characteristic information (e.g., video and/or audio information) to identify particular important and/or distinguishing characteristics thereof. As a non-limiting example, step 310 may comprise performing spectral analysis to identify particular speech characteristics associated with a person of interest or performing temporal signal analysis to identify particular temporal patterns of such speech. As another example, step 310 may comprise performing image analysis to indentify particular facial characteristics associated with a person of interest (e.g., eye color and/or location, retinal characteristics, facial feature dimensions and/or location, hair color and/or hairline location, complexion/color, height, face shape, existence of facial hair, etc.). Index information processed in such a manner may, for example, enhance the accuracy and/or real-time speed of processing. For example, personal index information acquired in real-time may be expeditiously analyzed for particular previously-identified distinguishing characteristics. Such directed analysis may, for example, be beneficial for temporally efficient and/or accurate database searching.

In general, step 310 may comprise receiving (or obtaining or acquiring) index information associated with a person of interest (e.g., a person of interest about whom personal record information is desired). Accordingly, the scope of various aspects of the present invention should not be limited by characteristics of any particular manner of such receiving (or obtaining or acquiring) unless explicitly claimed.

The exemplary method 300 may, at step 320, comprise searching (e.g., utilizing at least the index information received at step 310) a database for information associated with the person of interest. For example, step 320 may comprise utilizing index information comprising one or more physical characteristics of a person of interest to search a contact list for information about such person of interest. Non-limiting illustrations of such searching will now be provided.

In a first exemplary scenario, step 320 may comprise searching for personal record information associated with a person of interest based, at least in part, on face and/or image pattern recognition. For example, a user of a mobile computing device may utilize such device (e.g., at step 310) to obtain a photo of a person or interest for whom it is desired to retrieve personal record information. The mobile computing device may then (e.g., at step 320) utilize any of a variety of face and/or image pattern recognition algorithms to identify a person and/or personal record information associated therewith for presentation to the user. For example, step 320 may comprise finding a closest image match (or alternatively, a plurality of closest image matches) in the previously-stored image index information, and then pull the associated personal record information for presentation to the user.

In a second exemplary scenario, step 320 may comprise searching for personal record information associated with a person of interest based, at least in part, on voice, speech and/or audio pattern recognition. For example, a user of a mobile computing device may utilize such device (e.g., at step 310) to obtain a voice recording of a person of interest for whom it is desired to retrieve personal record information. The mobile computing device may then utilize any of a variety of voice and/or speech recognition algorithms or audio comparison algorithms to identify a person and/or personal record information associated therewith for presentation to the user. For example, step 320 may comprise finding a closest audio match (or alternatively, a plurality of closest audio matches) in the previously-stored audio index information, and then pull the associated personal record information for presentation to the user.

In a third exemplary scenario, step 310 may comprise searching for personal record information associated with a person of interest based, at least in part, on textual information. For example, a user of a mobile computing device may utilize a keypad of such device to input textual information descriptive of a person for which record information is desired. The mobile computing device may then utilize any of a variety of text matching algorithms to identify a person and/or personal record information associated therewith for presentation to the user. For example, step 320 may comprise finding a closest textual description match (or alternatively, a plurality of closest textual description matches) in the previously-stored textual index information, and then pull the associated personal record information for presentation to the user.

Note that in an exemplary scenario in which a plurality of potential matches are identified from the searching, step 320 may also comprise ranking (e.g., based on probability) the likelihood of such potential matches. For example, step 320 may identify the most likely N matches and order such potential matches based on likelihood. Further for example, step 320 may comprise associating specific probabilities with potential matches, so such probabilities may be presented to a user.

Such examples may also, for example, extend to utilizing more than one of the various personal characteristics discussed above. For example, a combination of image information, speech information and/or textual information may be utilized to search for personal record information associated with a person of interest.

Additionally for example, any of a variety of additional information may be utilized for such searching. As a non-limiting example, a search may be based on a combination of recorded audio information and location information. Also for example, a search may be based on a combination of image information and information of an organization with which a person of interest is associated. Additionally for example, a search may be based on a textual description that includes a guess of a person's name, one or more initials of a person's name, a geographical identifier, a general age, etc.

Further, as discussed previously, one or more databases may be utilized to store index and/or record information for people of interest. Accordingly, step 320 may comprise searching one or more databases, in one or more locations, locally and/or remotely through a communication network. Additionally, step 320 may also comprise performing general searches through a private network (e.g., a private company network) or a public network (e.g., the public Internet).

In general, step 320 comprises searching (e.g., utilizing at least the index information received at step 310), a database for information associated with the person of interest. Accordingly, the scope of various aspects of the present invention should not be limited by characteristics of any particular manner of performing such searching unless explicitly claimed.

After performing the searching at step 320, the exemplary method 300 comprises, at step 330, outputting information (e.g., personal record information) resulting from said searching to a user (e.g., a user of a mobile computing device). Step 330 may comprise performing such outputting in any of a variety of manners, non-limiting examples of which will now be provided. Note that such outputting may, for example and without limitation, comprise outputting a user-perceivable signal through a user output device, generating data to be output by a user output device, generating a signal to drive a user output device, etc.

For example, in a first exemplary scenario, step 330 may comprise providing to a user a list of available types of record information available. The user may then select the particular type(s) of information to receive. Step 330 may then comprise outputting such selected information to the user through any of a variety of user interface devices (e.g., video output devices, audio output devices, etc.).

In a second exemplary scenario, step 330 may comprise providing to a user a template of most popular information (e.g., a default template or a template defined by the user), from which other types of information may be selected for presentation to the user. For example, step 330 may provide a default set of personal record information to a user (e.g., name and affiliations) and then provide a user-interface mechanism by which the user may select different available types of information (e.g., any of the other types of record information discussed previously).

In a third exemplary scenario, step 330 may comprise providing to a user a user-interface mechanism by which the user may augment index and/or record information associated with a person of interest with the just-utilized index information or with other information of the user's choice. For example, a user might have just utilized a captured image to access personal record information about a person of interest, and the user may now augment either the index information and/or record information associated with the person of interest with such captured image.

As mentioned above, step 320 may identify more than one potential person of interest from its search. For example, step 320 may identify a most likely match, set of N most likely matches, ordered set of N most likely matches, list of N most likely matches with associated probabilities, etc. In such an exemplary scenario, step 330 may comprise presenting information of such plurality of potential matches to the user (e.g., in an ordered list, with associate probability information, etc.). Step 330 may then, for example, provide various user-interface mechanisms by which a user may peruse the candidate matches.

Alternatively, for example, step 330 may comprise providing a user interface with which a user may further refine the search (e.g., by eliminating match candidates from the list, by inputting additional index information, etc.). Step 330 may, for example, comprise receiving additional index (or search) information from the user and loop execution back up to step 320 for performing a more refined search. Alternatively, for example, step 330 may comprise performing additional filtering of the previously identified candidate records based on such additional index information.

As will be presented below in various system diagrams, step 330 may be performed utilizing any of a variety of user interface modules (e.g., hardware and/or software) and any of a variety of user interface devices (e.g., user interface devices provided with a mobile computing device).

The previous discussion focused primarily on various functional aspects of the present invention. As explained previously, such functional aspects may be performed by any of a variety of hardware and/or software components. For example, such hardware and/or software components may reside in a mobile computing device. The following discussion will provide non-limiting examples of various implementation aspects of the present invention.

Turning first to FIG. 4, such figure is a block diagram illustrating a non-limiting exemplary portable computing device 400 for providing personal characteristic-based recall of personal information, in accordance with various aspects of the present invention. For example, the mobile computing device 400 (e.g., the illustrated modules thereof) may perform any or all of the functional aspects discussed previously with regard to FIGS. 1-3.

The exemplary personal computing device 400 may, for example, comprise at least one processor 430 that operates to execute instructions stored in a memory 440 to implement any of the functional aspects discussed above. Such processor 430 may, for example, comprise a general-purpose processor, a digital signal processor (DSP), microcontroller, an application-specific integrated circuit (ASIC), etc.

The exemplary personal computing device 400 may also, for example, comprise at least one memory 440 which may, for example, be shared or dedicated. Such memory 440 may, for example, comprise application memory 442 utilized to store processor instructions for performing all or a portion of the previous mentioned functionality. Such memory 440 may also, for example, comprise database memory 444 utilized to store personal index and/or record information, as discussed previously. Such a database memory 444 may, for example, be completely on-board the mobile computing device. As discussed previously, however, such a database memory may be entirely remote from the mobile computing device (e.g., coupled through a communication link, which might be wired, wireless, tethered optical, non-tethered optical, etc.). Such a database memory 444 may also, for example, be a combination of on-board and off-board memory.

The exemplary personal computing device 400 may additionally, for example, comprise at least one User Interface Module 450 that operates to provide a user interface between the mobile computing device 400 and a user thereof. The User Interface Module 450 may, for example, comprise the hardware and/or software mechanisms by which a user may capture and/or enter and/or edit index information, as discussed above. Also for example, the User Interface Module 450 may comprise the hardware and/or software mechanisms by which a user may enter and/or edit record information, as discussed above. Further for example, the User Interface Module 450 may comprise the hardware and/or software mechanisms by which a user may utilize various aspects of the present invention to retrieve desired information regarding a person of interest.

The User Interface Module 450 may, for example, include any of a variety of interfaces and/or devices. For example, the User Interface Module 450 may comprise any of a variety of input devices, including hardware and/or software associated with utilizing such input devices (e.g., a camera for moving and/or still image capture, audio recorder, microphone, keypad, touch screen, etc.). Also for example, the User Interface Module 450 may comprise any of a variety of output devices, including hardware and/or software associated with utilizing such output devices (e.g., a video display [e.g., touch screen], a speaker, an earphone [e.g., wired or wireless], tactile output, etc.).

As discussed above, various aspects of the invention may utilize one or more databases, which may reside in a variety of locations (on-board and/or off-board the mobile computing device). The illustrated exemplary mobile computing device 400 comprises a Database Management Module 460 that operates to manage various aspects of storing/retrieving information from a database (e.g., managing storing information in a database, searching a database, retrieving information from a database, etc.). For example, the Database Management Module 460 may operate to perform any or all of the database management functionality discussed previously (e.g., in the discussion of FIGS. 1-3).

The Database Management Module 460 may, for example, comprise functional sub-modules to perform various aspects of database management. Such sub-modules may, for example, comprise sub-modules that operate to manage various types of input and/or output information and/or database searching. For example, the Database Management Module 460 may comprise a sub-module that operates to receive, determine, acquire and/or manage index information; a sub-module that operates to receive, determine, acquire and/or manage record information; and/or a sub-module the operates to manage various searching interaction with one or more databases.

The Database Management Module 460 may be implemented in hardware, software and/or a combination thereof. As a non-limiting example, though the Database Management Module 460 is illustrated as a stand-alone entity (for illustrative clarity), such module 460 may be implemented by the above-mentioned one or more processors 430 executing software/firmware instructions stored in the above-mentioned memory 442.

The exemplary mobile computing device 400 may also, for example, comprise a Database Utilization Module 470. The Database Utilization Module 470 may, for example, operate to manage various aspects of a user's utilization of a database including one or more database memories (e.g., Database Memory 444).

The Database Utilization Module 470 may, for example, operate to interact with a user, obtain index information from a user for performing a search, manage a database search utilizing obtained index information, utilize one or more user interface modules to interface with a user with regard to the results of a search operation, etc.). For example, the Database Utilization Module 470 may operate to perform any or all of the database utilization functionality discussed previously (e.g., in the discussion of FIGS. 1-3).

The Database Utilization Module 470 may, for example, comprise functional sub-modules to perform various aspects of database management. Such sub-modules may, for example, comprise sub-modules that operate to manage various types of input and/or output information and/or database searching. For example, the Database Utilization Module 470 may comprise a sub-module that operates to obtain index information from a user. Also for example, the Database Utilization Module 470 may comprise a sub-module that operates to perform a search based on obtained index information (e.g., packaging information for a search, performing the search, etc.). Further for example, the Database Utilization Module 470 may comprise a sub-module that operates to (e.g., in conjunction with the User Interface Module 450) outputting obtained record information to a user (e.g., outputting initial information to a user, interacting with a user to modify presentation format and/or information presented, etc.).

The Database Utilization Module 470 may be implemented in hardware, software and/or a combination thereof. As a non-limiting example, though the Database Utilization Module 470 is illustrated as a stand-alone entity (for illustrative clarity), such module 470 may be implemented by the above-mentioned one or more processors 430 executing software/firmware instructions stored in the above-mentioned memory 442.

The mobile computing device 400 may further, for example, comprise one or more Communication Interface Module(s) 410, 420 that operate to manage communication with devices or other entities external to the mobile computing device 400. For example, as discussed previously, various aspects of the present invention may comprise interacting with databases, search servers, and any of a variety of other information sources through a communication network. The Communication Interface Module(s) 410, 420 may, for example, operate to manage such communication (e.g., in accordance with any or a variety of communication protocols). The Communication Interface Module(s) 410, 420 may, for example, operate to manage communication with a telecommunication network, general data network, cable network, WLAN, WPAN, WMAN, wired television and/or television network, satellite communication network, etc. The First Communication Interface Module 410 operates to communicate through a wireless RF port 412. The Second Communication Interface Module 420 operates to communicate through a plurality of ports (e.g., a wireless RF communication port 422, a non-tethered optical communication port 424, a tethered optical communication port 426, and a wired communication port 428).

As discussed previously, various aspects of the present invention may comprise utilizing position information (e.g., for indexing and/or for record information). Accordingly, the exemplary mobile computing device 400 may comprise a Position-determining Module 480. The Position-determining Module 480 may, for example, operate to manage acquisition and/or processing of position information. Such operation may, for example, be performed in response to a user command and/or may be performed automatically without user interaction. For example, the Position-determining Module 480 may operate to interact with a satellite positioning system, like the Global Position System (GPS), a network performing Assisted GPS (AGPS), a terrestrial triangulation system (e.g., based on cellular triangulation), a premises-based (e.g., LAN) position determination system, etc.). In performing such operation, the Position-determining Module 480 may operate to utilize the Communication Interface Module(s) 410, 420 discussed above. As with all modules discussed herein, the Position-determining Module 480 may be implemented utilizing hardware, software and/or a combination thereof.

Also as discussed previously, various aspects of the present invention may comprise performing synchronization between the mobile computing device 400 and one or more other computing devices (e.g., a personal computer, a networked enterprise computer, an Internet server, etc.). For example, such synchronization may include synchronizing various computing devices to include recently updated information. Accordingly, the mobile computing device 400 may comprise a Synchronization Module 490 to manage such synchronization. For example, a mobile computing device that has just been utilized to obtain a new array of index and/or personal record information may be carried in-range of a desktop computer associated with the user. In such an exemplary scenario, the Synchronization Module 490 may operate to utilize the Communication Interface Modules 410, 420 to upload such recently obtained information to a desktop computer (e.g., on user command or automatically without user interaction).

The mobile computing device 400 illustrated in FIG. 4 was presented by showing various functional modules. Such a modular illustration was chosen for illustrative clarity. The scope of various aspects of the present invention, however, should not be limited by characteristics of such illustration unless explicitly claimed. For example, various modules may be implemented in hardware (dedicated or shared) and/or software. Accordingly, the scope of various aspects of the present invention should not be limited by various details regarding specific hardware and/or software implementations unless explicitly claimed. Also for example, various modules may, for example, share various hardware and software components. For example, a plurality of such modules may be implemented by a same processor implementing software instructions stored in a same memory, and a portion of such software instructions may be shared between various functional modules. Accordingly, the scope of various aspects should not be limited by arbitrary notions of separation and/or commonality between various modules unless explicitly claimed.

Another non-limiting exemplary system (e.g., a mobile computing device) is shown in FIG. 5. For example, FIG. 5 is a block diagram illustrating a non-limiting exemplary portable computing device 500 for providing personal characteristic-based recall of personal information, in accordance with various aspects of the present invention. The illustrated mobile computing device 500 may share any or all aspects with the exemplary mobile computing device 400 illustrated in FIG. 4 and discussed previously. For example, the mobile computing device 500 (or various modules thereof) may operate to perform any or all aspects of the exemplary functionality discussed previously with regard to FIGS. 1-3). For example, the illustrated mobile computing device 500 provides various non-limiting examples of various general modules discussed previously with regard to FIG. 4.

For example, the mobile computing device 500 comprises a processor 530. Such a processor 530 may, for example, share any or all characteristics with the processor 430 discussed with regard to FIG. 4. Also for example, the mobile computing device 500 comprises a memory 540. Such memory 540 may, for example, share any or all characteristics with the memory 440 discussed with regard to FIG. 4 (e.g., application 442 and/or database 444 memory).

Also for example, the mobile computing device 500 may comprise any of a variety of User Interface Module(s) 550. Such User Interface Module(s) 550 may, for example, share any or all characteristics with the user interface module(s) 450 discussed previously with regard to FIG. 4. For example and without limitation, the User Interface Module(s) 550 may comprise: a display device, a camera (for still or moving picture acquisition), a speaker, an earphone [e.g., wired or wireless], a microphone, a video screen [e.g., a touch screen], a vibrating mechanism, a keypad, and/or any of a variety of other user interface devices (e.g., a mouse, a trackball, a touch pad, light pen, game controlling device, etc.).

The exemplary mobile computing device 500 may also, for example, comprise any of a variety of communication modules (505, 506, and 510). Such communication module(s) may, for example, share any or all characteristics with the Communication Interface Module(s) 410, 420 discussed previously with regard to FIG. 4. For example and without limitation, the Communication Interface Module(s) 510 may comprise: a Bluetooth interface module; an IEEE 802.11, 802.15, 802.16 and/or 802.20 module; Any of a variety of cellular telecommunication interface modules (e.g., GSM/GPRS/EDGE, CDMA/CDMA2000/1x-EV-DO, WCDMA/HSDPA/HSUPA, TDMA/PDC, WiMAX, etc.); any of a variety of position-related communication interface modules (e.g., GPS, APGS, etc.); any of a variety of wired/tethered communication interface modules (e.g., USB, FireWire, RS-232, wireline and/or cable modem, etc.); any of a variety of communication interface modules related to communicating with external memory devices; etc. The exemplary mobile computing device 500 is also illustrated as comprising various wired 506 and/or wireless 505 front-end modules that may, for example, be included in the communication interface modules and/or utilized thereby.

The exemplary mobile computing device 500 may also comprise any of a variety of Signal Processing Module(s) 590. Such Signal Processing Module(s) 590 may, for example, be utilized to assist in processing various types of information discussed previously (e.g., with regard to video processing, image processing, audio processing, general user interface information data processing, etc.). For example and without limitation, the Signal Processing Module(s) 590 may comprise: Video/graphics Processing Modules (e.g. MPEG-2, MPEG-4, H.263, H.264, JPEG, TIFF, 3-D, 2-D, MDDI, etc.); Audio Processing Modules (e.g., MP3, AAC, MIDI, QCELP, AMR, CMX, etc.); and/or Tactile Processing Modules (e.g., Keypad I/O, touch screen processing, motor control, etc.).

The previous discussion provided various non-limiting examples of functionality and/or device architecture. The following discussion will provide non-limiting examples of various system scenarios and/or architectures in which various aspects of the present invention may be incorporated. For example and without limitation, the following discussion will provide illustrative system scenarios in which a mobile computing device implementing various aspects of the present invention may operate.

Turning first to FIG. 6, such figure is a diagram of an exemplary system environment 600 incorporating various aspects of the present invention. For example, the mobile computing device 605 and/or various other system entities illustrated may operate to perform any and/or all of the various aspects of the present invention discussed previously with regard to FIGS. 1-5. The exemplary system 600 may, for example, comprise a mobile computing device 605. The mobile computing device 605 may share any or all characteristics with the exemplary devices illustrated in FIGS. 4-5 and discussed previously and/or operate to implement any or all characteristics of the methods illustrated in FIGS. 1-3 and discussed previously.

The exemplary system 600 also comprises a variety of exemplary communication systems with which the mobile computing device 605 may communicate. For example, the exemplary system 600 comprises: a cellular Telecommunication Network 630, a first Wireless LAN 610, a second Wireless LAN 615, a Wireless MAN 620 and satellite communication network 690. The mobile computing device 605 may, for example, operate to communicate with and/or through such communication systems to store and/or acquire information (e.g., any of the index and/or record information discussed previously). For example, the mobile computing device 605 may communicate with any of the illustrated service providers through such communication systems.

The exemplary system 600 comprises: a Location Service Provider 670 with which the mobile computing device 605 may communicate to obtain positioning information. The exemplary system 600 also comprises a variety of illustrative service providers which may provide functional and/or information services to the mobile computing device 605. Such service providers may, for example, provide information of various respective types, which may be utilized for personal index and/or personal record information, as discussed previously. For example, such service providers are illustrated coupled to the Internet, but may be coupled to any of a variety of communication networks (private and/or public).

Such service providers may, for example and without limitation, comprise: a Weather Information Service Provider 665; an Investment/Financial Service Provider 668; a Music Service Provider 663; a Video Conference Provider 664; a News Service Provider 667; a Voice over Internet Protocol (VoIP) Provider 660; a Video Service Provider 666; an E-mail Service Provider 662; an Instant Messaging Service Provider 661; and/or a Telecommunication Provider 669.

Such service providers may also, for example, comprise a Central and/or Home Information Database Service 699. For example, the mobile computing device 605 may operate to utilize the Central and/or Home Information Database Service 699 for the storage and/or retrieval of at least a portion of the above-mentioned database information. Also for example, the mobile computing device 605 may operate to synchronize with the Central and/or Home Information Database Service 699, as discussed above. Similarly, such Central and/or Home Information Database Service 699 may be private (e.g., accessible only by the user or a defined group of users) or may be publicly accessible.

The mobile computing device may, for example, operate to communicate with any of such services (e.g., utilizing any of the illustrated communication networks) to process and/or obtain information related to various aspects of the present invention. For example, the mobile computing device 605 may operate to interface with any of such services to obtain information to associate with a particular person or group of people. Also for example, the mobile computing device 605 may operate to associate any of such services with a particular person or group (e.g., indicating any of such services as a source of information for a particular person of interest).

Turning next to FIG. 7, such figure provides another non-limiting system illustration. In particular, FIG. 7 is a diagram illustrating a non-limiting exemplary system 700 comprising exemplary mobile computing devices, in accordance with various aspects of the present invention. For example, the system 700 and/or various components thereof (e.g., the mobile computing devices 710, 720 and 730) may incorporate any or all aspects of the present invention as discussed previously with regard to FIGS. 1-6.

For example, the exemplary system 700 comprises a first mobile computing device 710 that operates to utilize a stand-alone internal database to perform the various database aspects of the present invention (e.g., as discussed previously with regard to FIGS. 1-6). The first mobile computing device 710 may, for example, operate to synchronize to a home or office computer (e.g., a desktop computer) for the exchange of information to maintain duplicate databases (e.g., for back-up).

The exemplary system 700 also comprise a second mobile computing device 720 that operates to utilize one or more external databases 750, 751 and no internal database to perform the various database aspects of the present invention (e.g., as discussed previously with regard to FIGS. 1-6). In such an exemplary system 700, the second mobile computing device 720 may depend entirely on communication with such external database(s) to perform various aspects of the present invention. The second mobile computing device 720 may, for example, operate to communicate with the external database(s) 750, 751 through one or more communication networks 740.

The exemplary system 700 further comprises a third mobile computing device 730 that operates to utilize one or more internal databases and one or more external databases 750, 751 to perform the various database aspects of the present invention (e.g. as discussed previously with regard to FIGS. 1-6). As a non-limiting example, the third mobile computing device 730 may operate to utilize the internal database(s) to store and/or maintain index information associated with a particular person, along with particular fundamental record information associated with such person, and operate to store and/or maintain various record information (e.g., record information associated with a relatively large amount of memory) in an external database with which the third mobile computing device 730 may communicate through one or more communication networks 740.

As mentioned previously, a database (e.g., a database internal to a mobile computing device and/or an external database) may (either automatically or on user command) update record and/or index information associated with various people of interest. In the external database example, such updating may, for example, be performed without expending relatively limited processing, memory and/or energy resources of a mobile computing device.

In summary, various aspects of the present invention provide a system and method in a mobile computing device for utilizing personal characteristics (e.g., physical characteristics) of a person of interest to manage and/or recall information associated with such person. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A mobile computing device, comprising:
at least one module of the mobile computing device operable to, at least:
receive index information indicative of at least one physical characteristic of a person;
search, utilizing at least the received index information, a contact list for information associated with said person; and
output information resulting from said search to a user of the mobile computing device.

2. The mobile computing device of claim 1, where said index information comprises a digital audio recording of said person.

3. The mobile computing device of claim 1, where said index information comprises a digital photograph of said person.

4. The mobile computing device of claim 1, where said index information comprises a textual description of at least one physical characteristic of said person.

5. The mobile computing device of claim 1, where said contact list comprises a stand-alone contact list independent of other applications.

6. The mobile computing device of claim 1, where said contact list comprises a contact list associated with an application independent of the at least one module.

7. The mobile computing device of claim 1, where said contact list resides in memory of the mobile computing device.

8. The mobile computing device of claim 1, where said contact list resides in a memory that is external to the mobile computing device and accessible to the mobile computing device via a communication network.

9. The mobile computing device of claim 1, where the at least one module is operable to:
receive second index information indicative of at least one non-physical characteristic of said person; and
search, utilizing at least the received index information and the received second index information, a contact list for information associated with said person.

10. The mobile computing device of claim 1, where the at least one module is operable to output information resulting from said search to a user of the mobile computing device by, at least in part, operating to indicate to the user types of information associated with said person that are available to be output to the user.

11. In a mobile computing device, a method comprising:
receiving index information indicative of at least one physical characteristic of a person;
searching, utilizing the received index information, a contact list for information associated with said person; and
outputting information resulting from said searching to a user of the mobile computing device.

12. The method of claim 11, where said index information comprises a digital audio recording of said person.

13. The method of claim 11, where said index information comprises a digital photograph of said person.

14. The method of claim 11, where said index information comprises a textual description of at least one physical characteristic of said person.

15. The method of claim 11, where said contact list comprises a stand-alone contact list independent of other applications.

16. The method of claim 11, where said contact list comprises a contact list associated with an application independent of modules of the mobile computing device implementing the method.

17. The method of claim 11, where said contact list resides in memory of the mobile computing device.

18. The method of claim 11, where said contact list resides in a memory that is external to the mobile computing device and accessible to the mobile computing device via a communication network.

19. The method of claim 11, comprising:
receiving second index information indicative of at least one non-physical characteristic of said person; and
searching, utilizing at least the received index information and the received second index information, a contact list for information associated with said person.

20. The method of claim 11, where outputting information resulting from said searching to a user of the mobile computing device comprises indicating to the user types of information associated with said person that are available to be output to the user.

21. A mobile computing device, comprising:
at least one module of the mobile computing device operable to, at least:
receive index information indicative of at least one physical characteristic of a person;
receive personal record information associated with said person; and
store the received personal record information in a contact list such that the stored personal record information is accessible in the contact list by searching based, at least in part, on information indicative of the at least one physical characteristic of said person.

22. The mobile computing device of claim 21, where said index information comprises a digital audio recording of said person.

23. The mobile computing device of claim 21, where said index information comprises a digital photograph of said person.

24. The mobile computing device of claim 21, where said index information comprises a textual description of at least one physical characteristic of said person.

25. The mobile computing device of claim 21, where said contact list comprises a stand-alone contact list independent of other applications.

26. The mobile computing device of claim 21, where said contact list comprises a contact list associated with an application independent of the at least one module.

27. The mobile computing device of claim 21, where said contact list resides in memory of the mobile computing device.

28. The mobile computing device of claim 21, where said contact list resides in a memory that is external to the mobile computing device and accessible to the mobile computing device via a communication network.

29. The mobile computing device of claim 21, where the at least one module is operable to:
receive second index information indicative of at least one non-physical characteristic of said person; and
store the received personal record information in the contact list such that the stored personal record information is accessible in the contact list by searching based, at least in part, on information indicative of the at least one physical characteristic and by information indicative of the at least one non-physical characteristic.

30. The mobile computing device of claim 21, where the at least one module is operable to store the received personal record information in the contact list such that the stored personal record information is accessible in the contact list by searching based, at least in part, on information indicative of the at least one physical characteristic and information indicative of a type of information desired by the user.

31. In a mobile computing device, a method comprising:
receiving index information indicative of at least one physical characteristic of a person;
receiving personal record information associated with said person; and
storing the received personal record information in a contact list such that the stored personal record information is accessible in the contact list by searching based, at least in part, on information indicative of the at least one physical characteristic of said person.

32. The method of claim 31, where said index information comprises a digital audio recording of said person.

33. The method of claim 31, where said index information comprises a digital photograph of said person.

34. The method of claim 31, where said index information comprises a textual description of at least one physical characteristic of said person.

35. The method of claim 31, where said contact list comprises a stand-alone contact list independent of other applications.

36. The method of claim 31, where said contact list comprises a contact list associated with an application independent of modules of the mobile computing device implementing the method.

37. The method of claim 31, where said contact list resides in memory of the mobile computing device.

38. The method of claim 31, where said contact list resides in a memory external to the mobile computing device and accessible to the mobile computing device via a communication network.

39. The method of claim 31, comprising:
receiving second index information indicative of at least one non-physical characteristic of said person; and
storing the received personal record information in the contact list such that the stored personal record information is accessible in the contact list by searching based, at least in part, on information indicative of the at least one physical characteristic and information indicative of the at least one non-physical characteristic.

40. The method of claim 31, comprising storing the received personal record information in the contact list such that the stored personal record information is accessible in the contact list by searching based, at least in part, on information indicative of the at least one physical characteristic and information indicative of a type of information desired by the user.
